(19) United States
(12) Patent Application Publication
(10) Pub. No.: US 2025/0214563 A1
(43) Pub. Date: Jul. 3, 2025

(54) ENSURING EQUITABLE PERFORMANCE OF HYBRID SYSTEMS

(71) Applicant: Robert Bosch GmbH, Stuttgart (DE)

(72) Inventors: Aakhilesh Singhania, Ypsilanti, MI (US); Jacob Thomas Riederer, Milford, MI (US)

(21) Appl. No.: 18/990,272

(22) Filed: Dec. 20, 2024

Related U.S. Application Data
(60) Provisional application No. 63/615,943, filed on Dec. 29, 2023.

(51) Int. Cl. B60W 20/13; B60W 10/08; B60W 20/11

(52) U.S. Cl. CPC B60W 20/13; B60W 10/08; B60W 20/11; B60W 2510/081; B60W 2510/083; B60W 2510/087; B60W 2510/244; B60W 2710/086

(57) ABSTRACT

A system for ensuring equitable performance of hybrid systems. The system includes a battery, an electric motor, and an electronic processor. The electronic processor is configured to determine power limits for the motor controller and determine physical torque limits based on physical limits of the battery and the electric motor. The electronic processor is also configured to determine modeled stator temperature and modeled rotor temperature limits. The electronic processor is further configured to determine a stator temperature and a rotor temperature, using the power limits for the motor controller, the physical torque limits, a coolant flow penalty factor, a coolant temperature penalty factor, and the modeled stator temperature and modeled rotor temperature limits, determine an overall torque minimum and an overall torque maximum, and control the electric motor based on the overall torque minimum and the overall torque maximum.

### RELATED APPLICATIONS

This application claims priority to U.S. Provisional Patent Application No. 63/615,943, filed Dec. 29, 2023, the entire content of which is hereby incorporated by reference.

### SUMMARY

It is often important in motor sports that vehicles involved in the race have similar or equal performance capabilities. For example, in many racing events, vehicles must perform within mandatory rules or regulations and a failure to do so can result in a disqualification. The regulations are designed to help ensure fair competition between drivers in motor sporting events and racing competitions or series, for example, Formula 1, Formula 2, and other racing series sanctioned or governed by various governing entities. In certain racing series, vehicle constructors may use different components provided that those components meet the regulations promulgated by the governing entity. In certain instances, components are shared among vehicle constructors. When components with part-by-part variation (for example, variation between internal combustion engines, electric motors, cooling systems, batteries, and others)) are used by vehicle constructors, but a hybrid vehicle is mandated by regulation, numerous technical challenges arise. One challenge occurs when the same hybrid control unit is incorporated into vehicles which have components with part-on part variation (for example, differences between the quality of materials included in the components and differences between component usage). The implementations described herein provide, among other things, systems and methods for ensuring equitable performance of hybrid systems. The implementations described herein allow, among other things, a single hybrid control unit to be installed into hybrid racing vehicles with components having part-by-part variation while ensuring equal system-level performance and derating behavior across hybrid systems.

One implementation provides a system for ensuring equitable performance of hybrid systems. The system includes a battery, an electric motor, and an electronic processor. The electronic processor is configured to determine power limits for the motor controller and determine physical torque limits based on physical limits of the battery and the electric motor. The electronic processor is also configured to, based on a coolant flow rate, determine a coolant flow penalty factor, based on a first coolant temperature and a second coolant temperature, determine a coolant temperature penalty factor, and determine modeled stator temperature and modeled rotor temperature limits. The electronic processor is further configured to determine a stator temperature and a rotor temperature, using the power limits for the motor controller, the physical torque limits, the coolant flow penalty factor, the coolant temperature penalty factor, and the modeled stator temperature and modeled rotor temperature limits, determine an overall torque minimum and an overall torque maximum, and control the electric motor based on the overall torque minimum and the overall torque maximum.

Another implementation provides a method for ensuring equitable performance of hybrid systems. The method includes determining power limits for the motor controller that is available from a battery to an electric motor and determining physical torque limits based on physical limits of the battery and the electric motor. The method also includes, based on a coolant flow rate, determining a coolant flow penalty factor, based on a first coolant temperature and a second coolant temperature, determining a coolant temperature penalty factor, and determining modeled stator temperature and modeled rotor temperature limits. The method further includes determining a stator temperature and a rotor temperature, determining an overall torque minimum and an overall torque maximum using the power limits for the motor controller, the physical torque limits, the coolant flow penalty factor, the coolant temperature penalty factor, and the modeled stator temperature and modeled rotor temperature limits, and controlling the electric motor based on the overall torque minimum and the overall torque maximum.

### BRIEF DESCRIPTION OF THE DRAWINGS

FIG. 1 provides an illustrative example of a system for ensuring equitable performance of hybrid systems.

FIG. 2 provides an illustrative example of a hybrid control unit included in the system of FIG. 1.

FIG. 3 provides an illustrative example of a motor generator unit included in the system of FIG. 1.

FIG. 4 provides an illustrative example of a motor control unit included in the system of FIG. 1.

FIG. 5 provides an illustrative example of a method for ensuring equitable performance of hybrid systems.

FIG. 6 provides an illustrative example of the inputs used to perform the method of FIG. 5 and the outputs generated when the method of FIG. 5 is performed.

FIG. 7A to FIG. 7C provide an illustrative example of the sub functions included in the SYSEQUITY block of FIG. 6.

FIG. 8A to FIG. 8E provide an illustrative example of the sub functions included in the SysEquity_Mgu_Mcu block of FIG. 7B and FIG. 7C.

FIG. 9A and FIG. 9B provide an illustrative example of the sub functions included in the MGU_PERFORMANCE block of FIG. 8D.

### DETAILED DESCRIPTION

Before any aspects, features, or instances are explained in detail, it is to be understood that the aspects, features, or instances are not limited in their application to the details of construction and the arrangement of components set forth in the following description or illustrated in the following drawings. Other instances are possible and are capable of being practiced or of being carried out in various ways.

Also, it is to be understood that the phraseology and terminology used herein is for the purpose of description and should not be regarded as limiting. The terms “mounted,” “connected” and “coupled” are used broadly and encompass both direct and indirect mounting, connecting, and coupling. Further, “connected” and “coupled” are not restricted to physical or mechanical connections or couplings, and can include electrical connections or couplings, whether direct or indirect. Also, electronic communications and notifications may be performed using any known means including wired connections, wireless connections, etc.

It should also be noted that a plurality of hardware and software based devices, as well as a plurality of different structural components may be utilized in various implementations. Aspects, features, and instances may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one instance, the electronic based aspects of the invention may be implemented in software (for example, stored on non-transitory computer-readable medium) executable by one or more processors. As a consequence, it should be noted that a plurality of hardware and software based devices, as well as a plurality of different structural components may be utilized to implement the invention. For example, “control units” and “controllers” described in the specification can include one or more electronic processors, one or more memory modules including a non-transitory computer-readable medium, one or more communication interfaces, and various connections (for example, a system bus) connecting the components. It should be understood that although certain drawings illustrate hardware and software located within particular devices, these depictions are for illustrative purposes only. In some instances, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

For case of description, some or all of the example systems presented herein are illustrated with a single exemplar of each of its component parts. Some examples may not describe or illustrate all components of the systems. Other instances may include more or fewer of each of the illustrated components, may combine some components, or may include additional or alternative components.

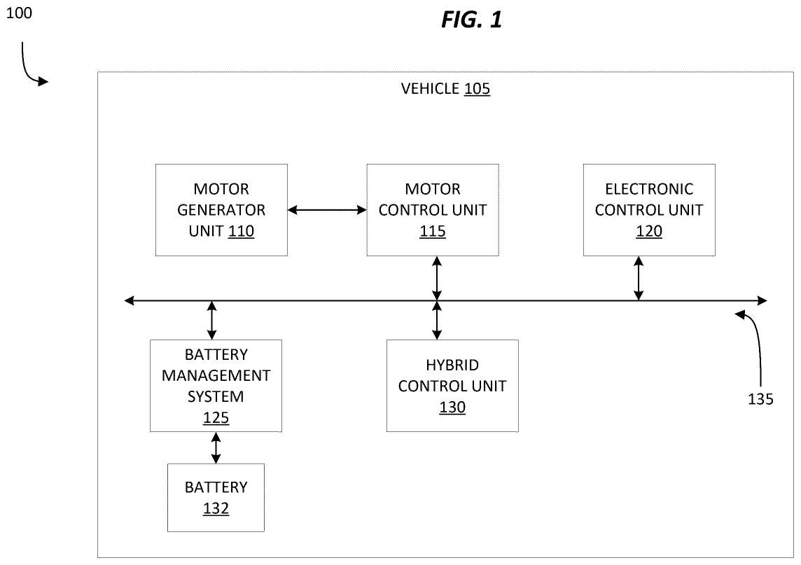

FIG. 1 provides an illustrative example of a system 100 for ensuring equitable performance of hybrid systems. The system 100 includes a vehicle 105. The vehicle 105 may be, for example, a hybrid motor sports vehicle that is configured to be driven in vehicle racing competitions. The vehicle 105 may include a motor generator unit (“MGU”) 110, a motor control unit (“MCU”) 115, an electronic control unit (“ECU”) 120, a battery management system (“BMS”) 125, a hybrid control unit (“HCU”) 130, and a battery 132. The MGU 110, the MCU 115, the ECU 120, the BMS 125, the HCU 130, and the battery 132 may be electronically and communicatively coupled via one or more wireless or wired connections. In one example implementation, the MCU 115, the ECU, the BMS 125, and the HCU 130 communicate by or through one or more control or data buses (for example, the bus 135), which enable communication therebetween. In some instances, the bus 135 is a Controller Area Network (CAN™) bus. In some instances, the bus 135 is an automotive Ethernet™, a FlexRay™ communications bus, or another suitable bus. In alternative instances, some or all of the components of the vehicle 105 may be communicatively coupled using suitable wireless modalities (for example, Bluetooth™ or near field communication connections). In some implementations, the MGU 110 is electrically and communicatively coupled to only the MCU 115. In other implementations the MGU 110 is electrically and communicatively coupled to, in addition to the MCU 115, other components included in the vehicle 105. In some implementations, the battery 132 is electrically and communicatively coupled to the BMS 125.

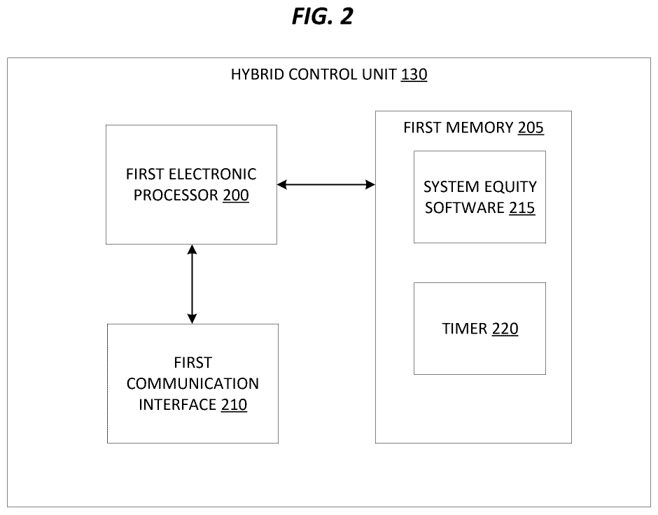

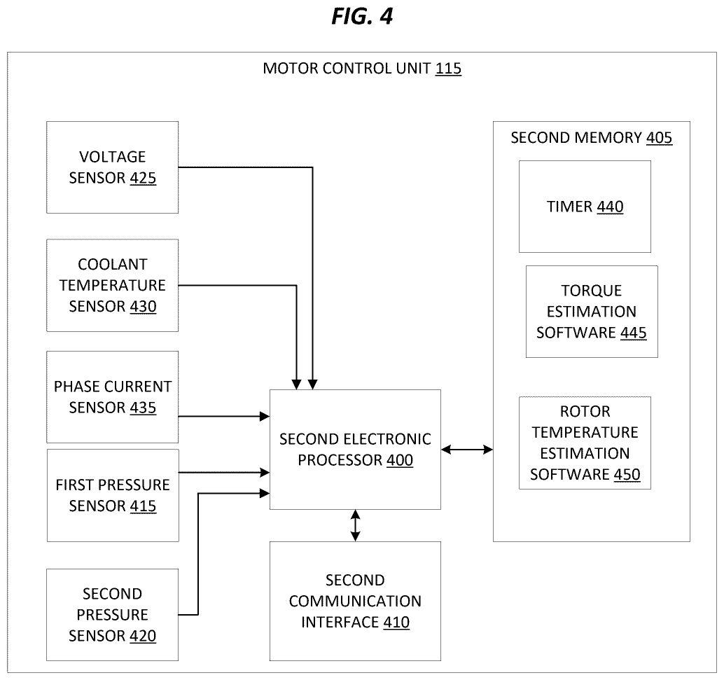

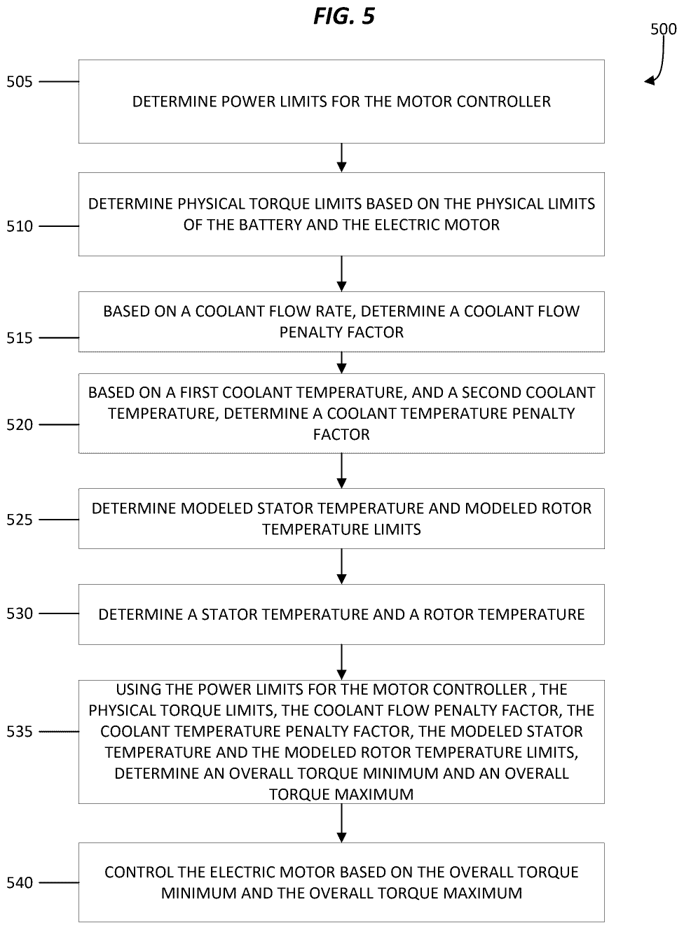

FIG. 2 provides an illustrative example of the components included in the hybrid control unit 130 included in the system 100. In some implementations, the hybrid control unit 130 includes a first electronic processor 200 (for example, a microprocessor, application specific integrated circuit, etc.), a first memory 205, and a first communication interface 210. The first memory 205 may be made up of one or more non-transitory computer-readable media and includes a program storage area and a data storage area. The program storage area and the data storage area can include combinations of different types of memory, such as read-only memory (“ROM”), random access memory (“RAM”), electrically erasable programmable read-only memory (“EEPROM”), flash memory, or other suitable memory devices. The first electronic processor 200 is coupled to the first memory 205 and the first communication interface 210. The first electronic processor 200 sends and receives information (for example, from the first memory 205, the first communication interface 210, or both) and processes the information by executing one or more software instructions or modules, capable of being stored in the first memory 205, or another non-transitory computer readable medium. The software can include firmware, one or more applications, program data, filters, rules, one or more program modules, and other executable instructions. In the illustrated example, the first memory 205 includes, among other things, system equity software 215 and a timer 220. When the first electronic processor 200 executes the system equity software 215, the first electronic processor 200 may perform the functionality described below in relation to FIG. 5. In some implementations, the timer 220 is configured to track an amount of time that the ECU 120 has been off for. In some implementations, the timer 220 is included in the ECU 120 rather than the first memory 205 and the first electronic processor 200 may receive the amount of time from the ECU 120 via the first communication interface 210. In some implementations, a timer for tracking an amount of time that the ECU 120 has been off for may be included in the MCU 115 (illustrated by the timer 440 in FIG. 4). The first communication interface 210 transmits and receives information from devices external to the hybrid control unit 130 (for example, components of the vehicle 105 via the bus 135).

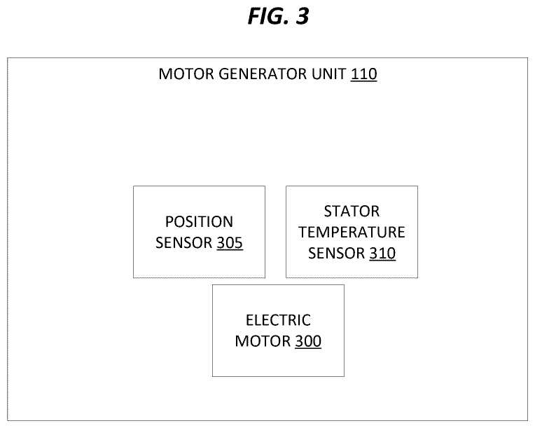

FIG. 3 provides an illustrative example of the components included in the MGU 110. In some implementations, the MGU 110 includes an electric motor 300, a position sensor 305, and a stator temperature sensor 310. In some implementations, the electric motor 300 includes a stator, a rotor, an output shaft, and the like. The position sensor 305 may be configured to measure or determine the position of the output shaft of the electric motor 300 in order to allow the torque of the electric motor 300 and speed of the electric motor 300 to be determined. In some implementations, the stator temperature sensor 310 is configured to determine or measure the temperature of the stator of the electric motor 300. It should be understood that the MGU 110 may include additional or different components than those illustrated in FIG. 3. For example, the MGU 110 may include two sensors configured to measure or determine the stator temperature rather than the single stator temperature sensor 310 illustrated in FIG. 3.

FIG. 4 provides an illustrative example of components included in the motor control unit 115 of the system 100. In some implementations, the motor control unit 115 includes a second electronic processor 400, a second memory 405, a second communication interface 410, a first pressure sensor 415, a second pressure sensor 420, a voltage sensor 425, a coolant temperature sensor 430, and a phase current sensor 435. In some implementations, the MCU 115 includes multiple temperature sensors rather than the single coolant temperature sensor 430 illustrated in FIG. 4. For example, the MCU 115 includes a first coolant temperature sensor configured to measure the first input or inlet coolant temperature for the MCU 115 and a second coolant temperature sensor configured to measure the second input or inlet coolant temperature for the MGU 110. The second electronic processor 400 is coupled to the second memory 405 and the second communication interface 410. In some implementations, the second electronic processor 400, the second memory 405, and the second communication interface 410 are designed and configured in a similar manner to the first electronic processor 200, the first memory 205, and the first communication interface 210 described above. In some implementations, the second memory 405 includes a timer 440, torque estimation software 445, and rotor temperature estimation software 450. In some implementations, when the second electronic processor 400 executes the torque estimation software 445, the second electronic processor 400 determines a torque output by the electric motor 300. In some implementations, when the second electronic processor 400 executes the rotor temperature estimation software 450, the second electronic processor 400 estimates a measured temperature of the rotor of the electric motor 300. In other implementations, the MGU 110 may include a rotor temperature sensor that is configured to measure the temperature of the rotor of the electric motor 300. It will be apparent to one of ordinary skill in the art how the second electronic processor 400 determines the torque of the electric motor 300 and the temperature of the rotor of the electric motor 300 by executing the torque estimation software 445 and rotor temperature estimation software 450, respectively.

In some implementations, the first pressure sensor 415, the second pressure sensor 420, the voltage sensor 425, the coolant temperature sensor 430, and the phase current sensor 435 are electrically and communicative coupled to the second electronic processor 400 via one or more wired or wireless connections. In some implementations, the first pressure sensor 415, the second pressure sensor 420, the voltage sensor 425, the coolant temperature sensor 430, and the phase current sensor 435 communicate with the second electronic processor 400 via one or more intermediary devices. In some implementations, the first pressure sensor 415 and the second pressure sensor 420 are configured to measure the pressure of coolant as it moves through a line or a pipe designed to cool the MGU 110. For example, the first pressure sensor 415 is configured to measure a first coolant pressure at a first location (for example, a beginning of the pipe or line for cooling the MGU 110) and the second pressure sensor 420 is configured to measure a second coolant pressure at a second location (for example, an end point of the pipe or line for cooling the MGU 110). In some implementations, the phase current sensor 435 is configured to measure the phase current of the electric motor 300. In some implementations, the coolant temperature sensor 430 is configured to measure a first input coolant temperature and a second input coolant temperature. In some implementations, the first input coolant temperature is the temperature of the coolant as it enters a line or a pipe designed to cool the MCU 115. In some implementations, the second input coolant temperature is the temperature of the coolant as it enters a line or a pipe designed to cool the MGU 110. In some implementations, the voltage sensor 425 is configured to measure the voltage provided by the battery 132 to the MCU 115. In some implementations, the voltage sensor 425 is configured to measure the voltage of the battery 132. In some implementations, the voltage sensor 425 may be included in the battery 132 or BMS 125 rather than the MCU 115.

FIG. 5 provides an example method 500 for ensuring equitable performance of hybrid systems. In some implementations, the method 500 begins at step 505 when the first electronic processor 200 determines power limits for a motor controller. In some implementations, the first electronic processor 200 determines the power limits for the motor controller using minimum and maximum power associated with the battery 132, a DCDC converter voltage, a current, and a power value. The minimum and maximum power associated with the battery 132, the DCDC converter voltage, the current, and the power value used to determine power limits for the motor controller may be received by the first electronic processor 200 from the BMS 125. One of ordinary skill in the art will appreciate how the minimum and maximum power associated with the battery 132, the DCDC converter voltage, the current, and the power value are determined by the BMS 125.

At step 510, the first electronic processor 200 determines physical torque limits based on the physical limits of the battery 132 and the electric motor 300. For example, the physical torque limits account for the physical limits imposed by the electromechanical design of the electric motor 300 and the power that the battery 132 is able to supply. In some implementations, the physical torque limits include a minimum physical torque and a maximum physical torque. In some implementations, the first electronic processor 200 determines the physical torque limits using one or more operating points (for example, a speed of the electric motor 300, a torque of the electric motor 300, and a voltage of the battery 132) and the power limits for the motor controller. The speed of the electric motor 300 and the torque of the electric motor 300 may be received by the first electronic processor 200 from the MCU 115. The voltage of the battery 132 may be received by the first electronic processor 200 from the BMS 125.

At step 515, the first electronic processor 200, based on a coolant flow rate, determines a coolant flow penalty factor. In some implementations, the first electronic processor 200 determines the coolant flow rate using a first coolant pressure and a second coolant pressure received by the first electronic processor 200 from the motor control unit 115. In some implementations, the coolant flow penalty factor is non-zero when the coolant flow rate is less than a predetermined flowrate threshold. In some implementations, the coolant flow penalty factor is zero when the coolant flow rate is equal to or greater than the predetermined flowrate threshold. At step 520, the first electronic processor 200, based on a first coolant temperature and a second coolant temperature, determines a coolant temperature penalty factor. In some implementations, the first electronic processor 200 determines the coolant temperature penalty factor using a first coolant temperature and the second coolant temperature determined by the coolant temperature sensor 430 and received from the MCU 115. In some implementations, the coolant temperature penalty factor is zero when the first coolant temperature and the second coolant temperature, are less than or equal to a predetermined coolant temperature threshold. Determining the coolant temperature penalty factor and the coolant pressure penalty factor allows the first electronic processor 200 to ensure similar performances across hybrid systems even if one hybrid system has a more effective cooling system than another hybrid system.

At step 525, the first electronic processor 200 determines modeled stator temperature and modeled rotor temperature limits. In some implementations, the modeled stator temperature and modeled rotor temperature limits include a minimum torque determined based on a modeled stator temperature and a modeled rotor temperature and a maximum torque determined based on the modeled stator temperature and the modeled rotor temperature.

In some implementations, the first electronic processor 200 determines the modeled rotor temperature using a speed of the electric motor 300, a torque of the electric motor 300, a voltage of the battery 132, a switching method of the electric motor 300, a switching frequency of the electric motor 300, a phase current of the electric motor 300, and an initial rotor temperature (described below). In some implementations, the first electronic processor 200 determines the modeled stator temperature and using a speed of the electric motor 300, a torque of the electric motor 300, a voltage of the battery 132, a switching method of the electric motor 300, a switching frequency of the electric motor 300, a phase current of the electric motor 300, and an initial stator temperature (described below). In some implementations, the computation performed by the first electronic processor 200 to determine the modeled stator temperature and the modeled rotor temperature is based on an efficiency associated with converting DC power to AC power in the MCU 115, an efficiency associated with converting electrical energy to mechanical energy in the MGU 110, an amount of heat generated by the MGU 110 and MCU (taking into account the effects of the cooling system), and the physical and thermal properties of the stator and rotor.

In some implementations, the first electronic processor 200 determines the initial stator temperature using the second coolant temperature, the measured value of the stator temperature, and an amount of time that the ECU 120 is off. The first electronic processor 200 may determine the initial rotor temperature using the second coolant temperature, the measured value of the rotor temperature, and an amount of time that the ECU 120 is off. For example, the first electronic processor 200 may compare the amount of time that the ECU 120 is off to a predetermine threshold. It should be understood that the amount of time that the ECU 120 is off is the amount of time that has passed since the ECU 120 last performed an operation. When the amount of time that the ECU 120 is off is greater than a predetermined threshold, the first electronic processor 200 calculates the initial stator temperature based on the second coolant temperature and the measured value of the stator temperature and calculates the initial rotor temperature based on the second coolant temperature and the measured value of the rotor temperature. When the amount of time that the ECU 120 is off is less than or equal to the predetermined threshold, the first electronic processor 200 determines the initial stator temperature and the initial rotor temperature to be the most recently determined stator temperature and rotor temperature respectively (in other words, the stator temperature and rotor temperature determined during the most previous execution of step 530 of the method 500). In some implementations, the first electronic processor 200 receives the measured stator temperature and the measured rotor temperature from the MCU 115.

At step 530, the first electronic processor 200 may determine, using arbitration techniques, a stator temperature and a rotor temperature. In some implementations, the first electronic processor 200 stores the stator temperature and the rotor temperature determined at step 530 in the first memory 205. In some implementations, the first electronic processor 200 determines the stator temperature and the rotor temperature to be one of 1) the measured stator temperature and the measured rotor temperature, 2) the initial stator temperature and the initial rotor temperature, and 3) the modeled stator temperature and the modeled rotor temperature. The arbitration techniques utilized at step 530 include, when the measured stator temperature and the measured rotor temperature are valid, determining the stator temperature and the rotor temperature to be the maximum or greatest of measured and modeled stator and rotor temperatures. A measured temperature may be valid when no error (for example, physical damage of the electrical aspects of the temperature sensor) is associated to the measurement of the temperatures. When the measured stator temperature and the measured rotor temperature are invalid, the stator temperature and the rotor temperature may be determined to be the modelled stator temperature and the modeled rotor temperature regardless of the measured temperatures.

At step 535, the first electronic processor 200 may determine, using arbitration techniques, an overall torque minimum and an overall torque maximum using the power limits for the motor controller, the physical torque limits, the coolant flow penalty factor, the coolant temperature penalty factor, and the modeled stator temperature and modeled rotor temperature limits. In some implementations, the overall torque minimum and the overall torque maximum are the most conservative values possible based on the power limits for the motor controller, the physical torque limits, the coolant flow penalty factor, the coolant temperature penalty factor, and the modeled stator temperature and modeled rotor temperature limits. In some implementations, the arbitration techniques utilized at step 535 include determining the overall torque minimum and the overall torque maximum to be values that ensure that limits (for example, power limits for the motor controller, the physical torque limits, the coolant flow penalty factor, the coolant temperature penalty factor, and the modeled stator temperature and modeled rotor temperature limits) are not exceeded or dropped below. For example, when in the positive torque domain (deployment torque), overall maximum torque is selected based on the minimum or smallest limit and, when in the negative torque domain (regenerative torque), the overall minimum torque is selected based on the maximum or greatest limit.

At step 540, the first electronic processor 200 may control the electric motor 300 based on the overall torque minimum and the overall torque maximum. In some implementations, the first electronic processor 200 may control the electric motor 300 based on the overall torque minimum and the overall torque maximum. In some implementations, the first electronic processor 200 may control the electric motor based on the stator temperature, and the rotor temperature as well as the overall torque minimum and the overall torque maximum. For example, the first electronic processor 200 may derate the electric motor 300 based on the overall torque minimum, the overall torque maximum, the stator temperature, and the rotor temperature.

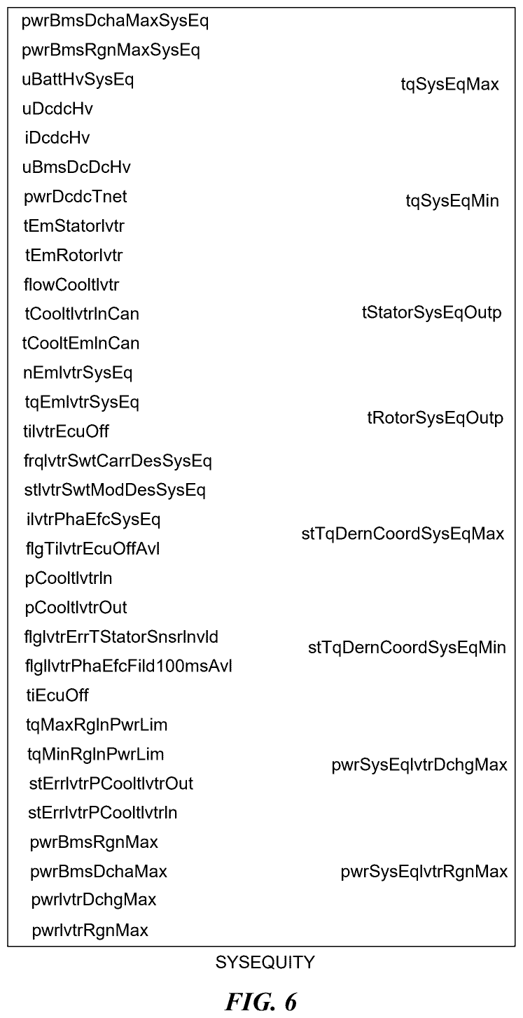

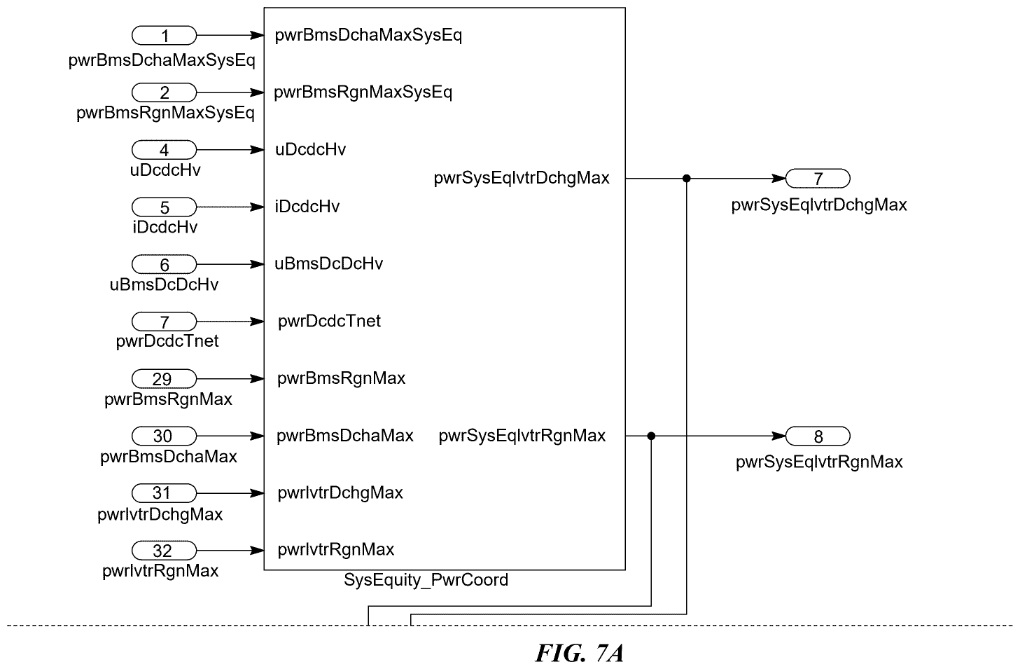

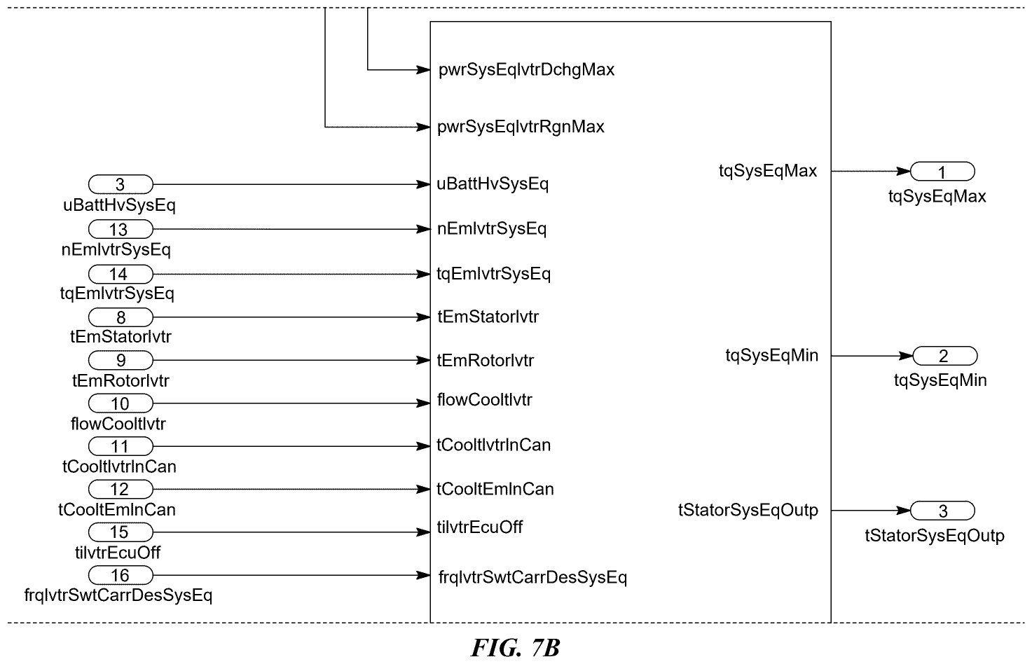

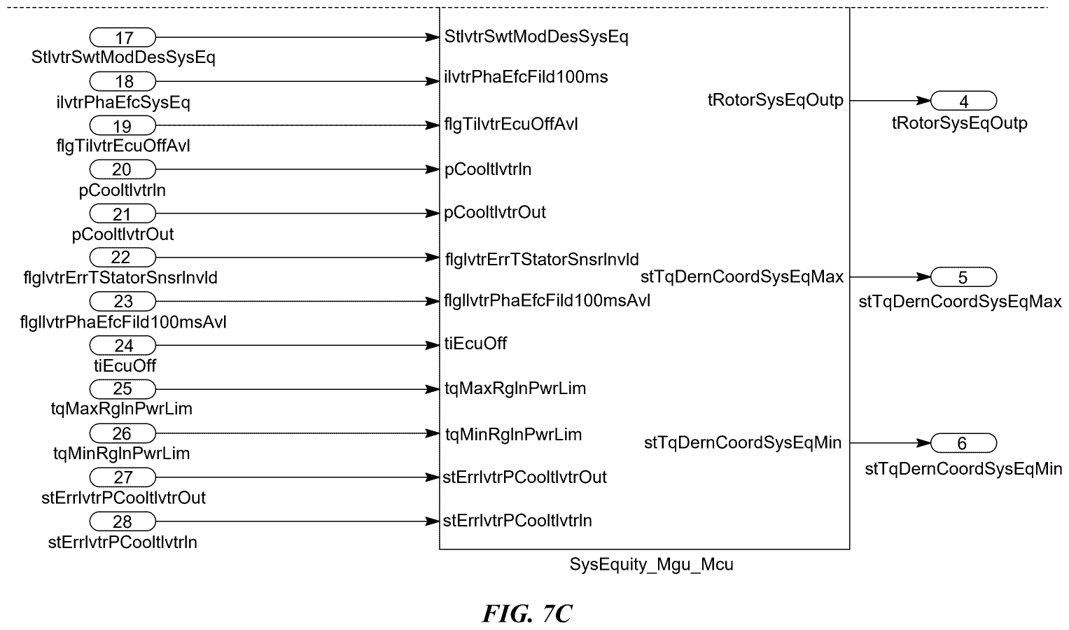

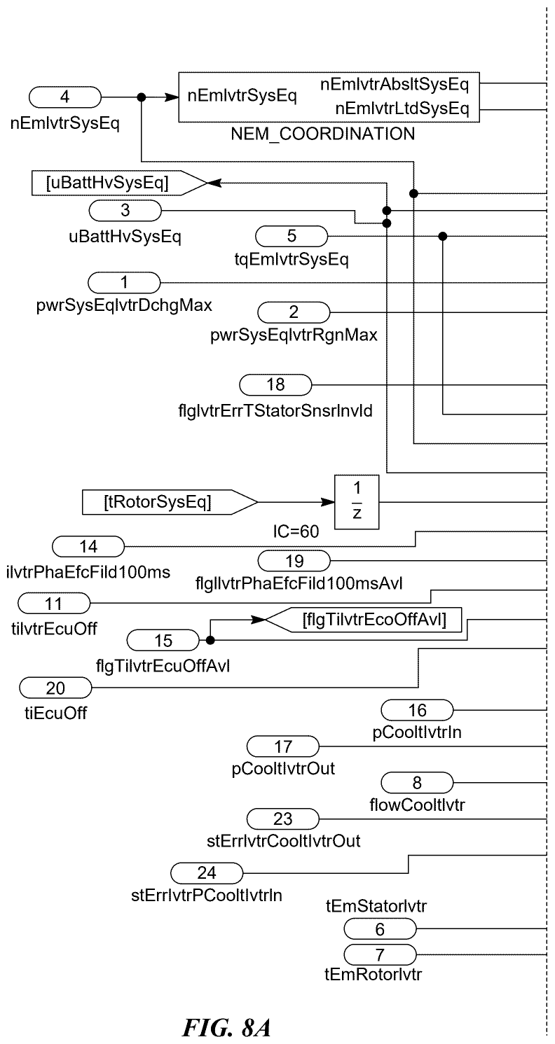

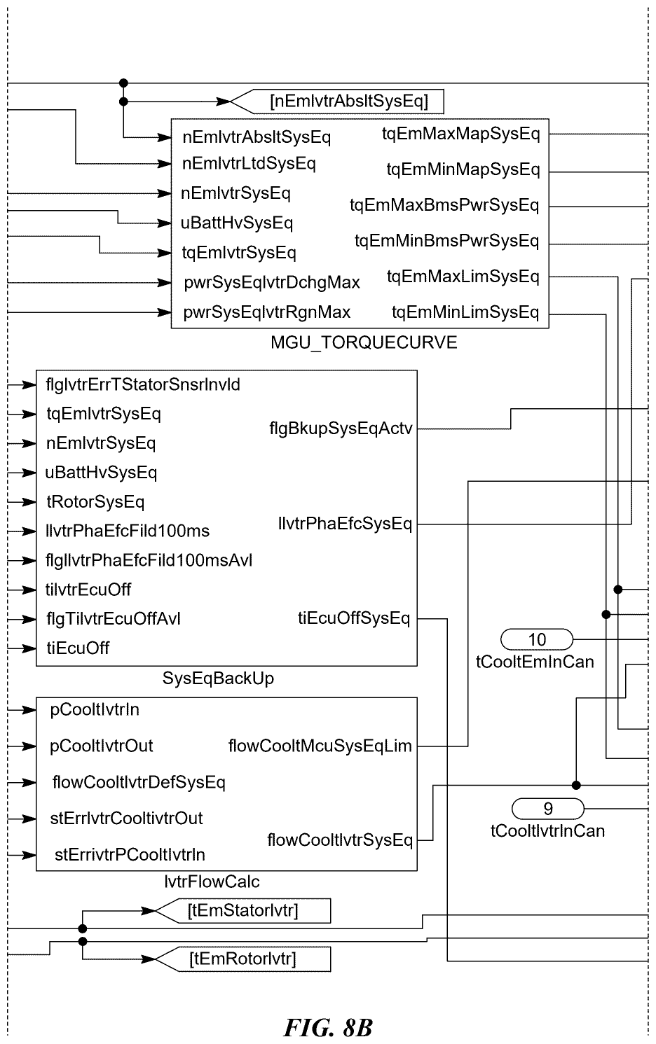

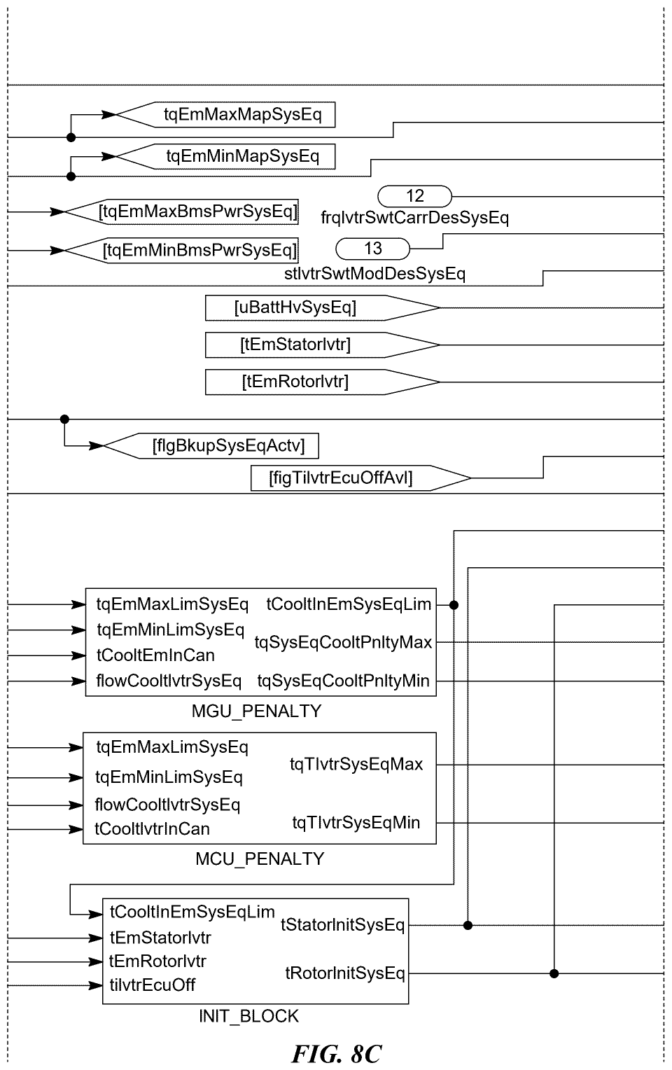

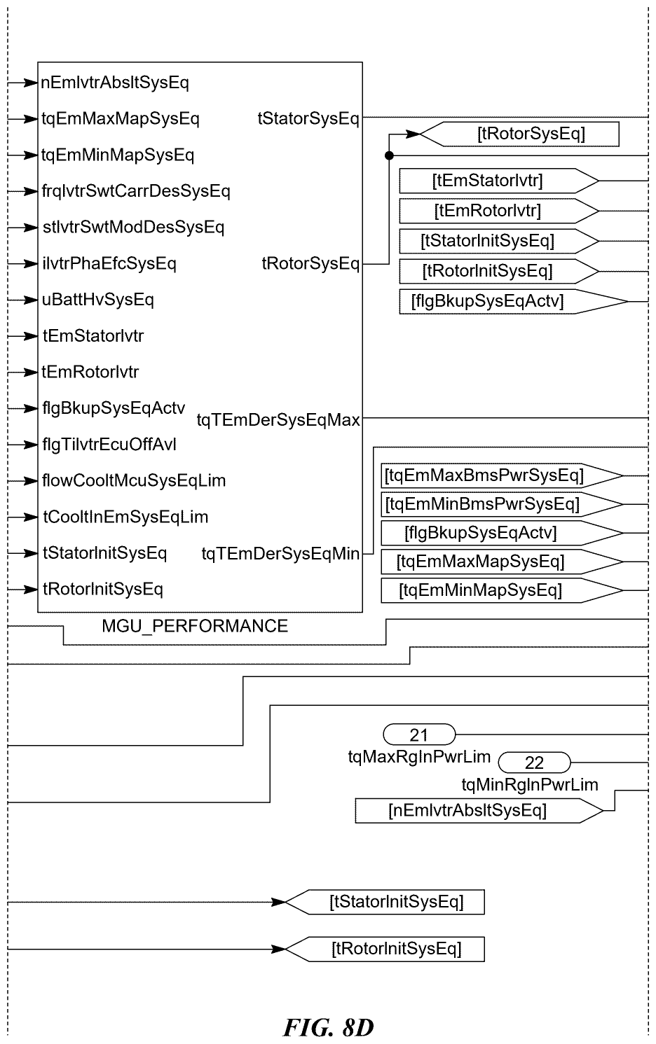

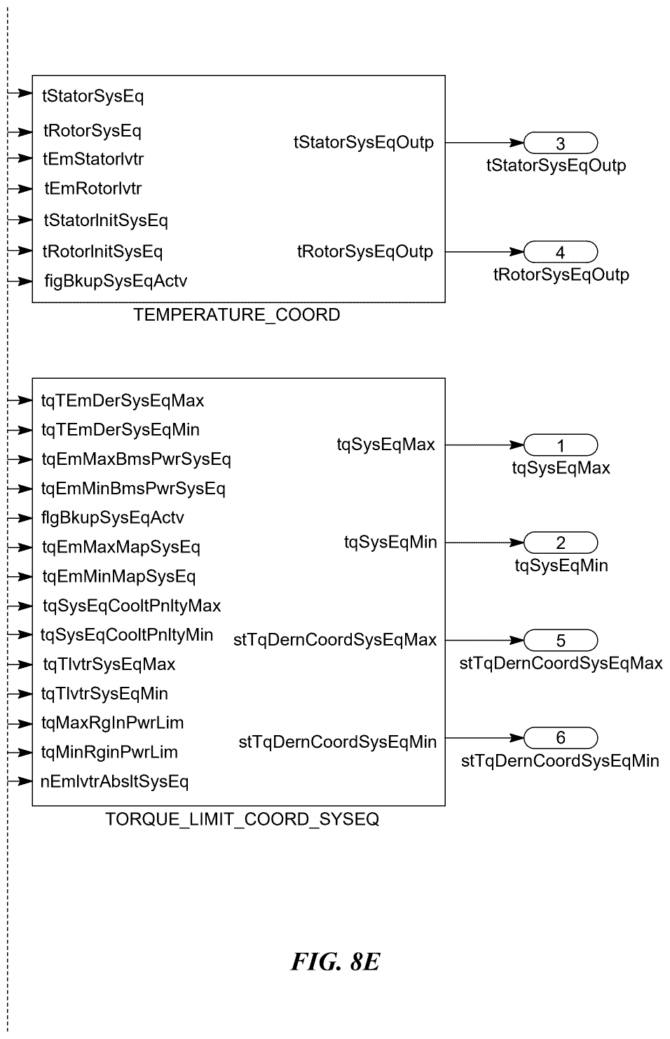

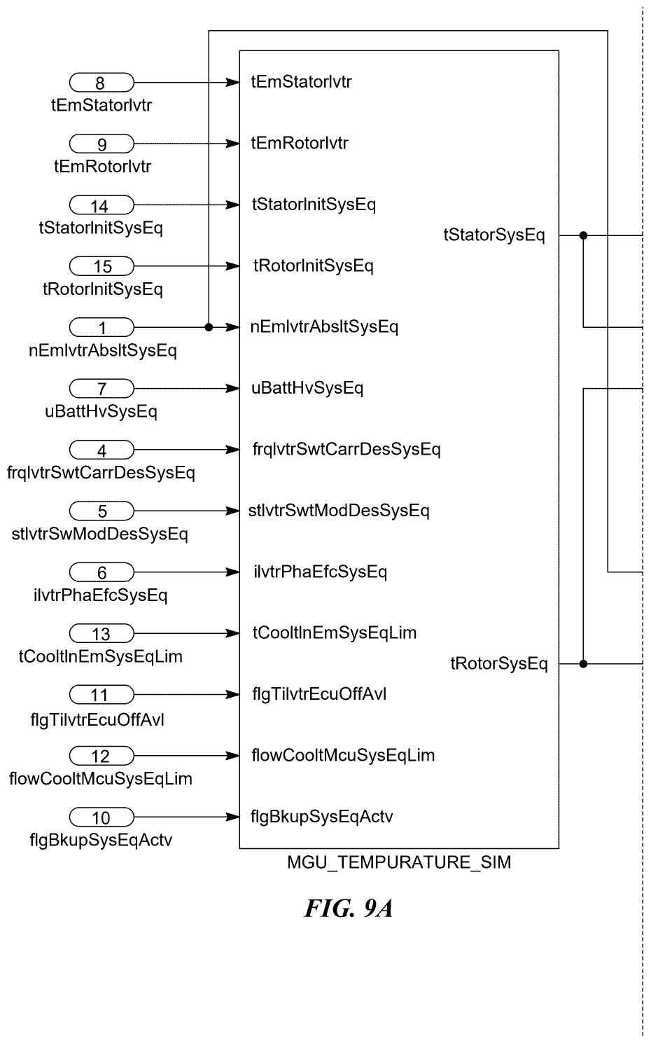

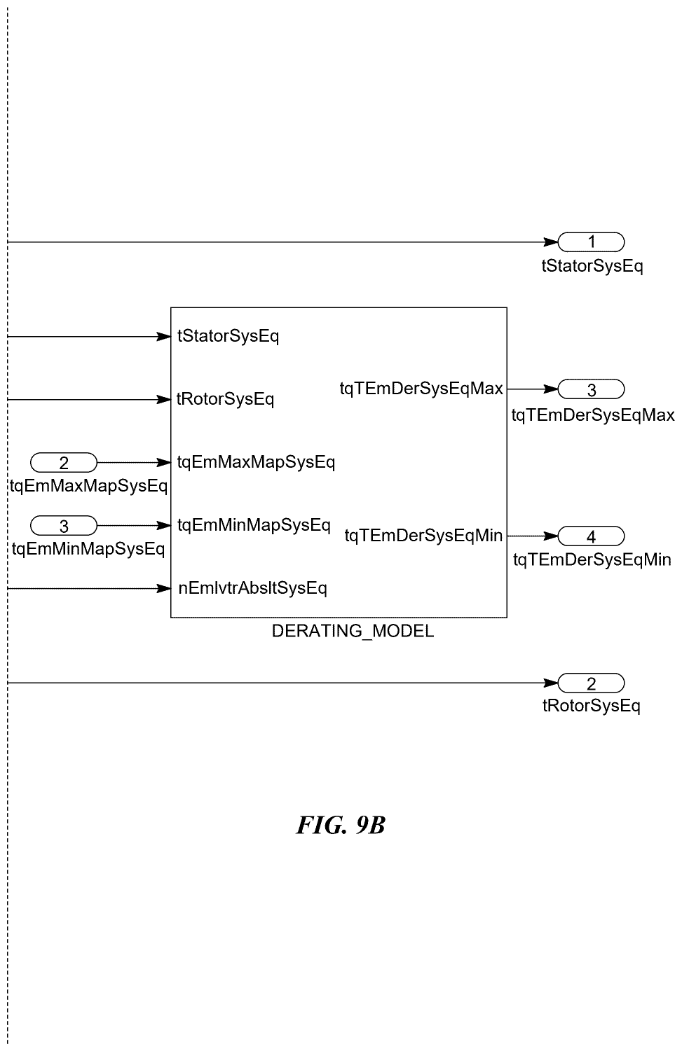

The functionality performed by some subfunctions illustrated as blocks in FIG. 6 to FIG. 9B are described below in accordance with some implementations. The functionality of some subfunctions that are not illustrated as blocks in FIG. 6 to FIG. 9B are also described below in accordance with some implementations.

FIG. 6 provides an illustrative example of the inputs used to perform the method 500 of FIG. 5 and the outputs generated when the method of FIG. 5 is performed. In addition to illustrating the stator temperature, the rotor temperature, the overall torque minimum, the overall torque maximum outputs (tqSysEqMax, tqSysEqMin, tStatorSysEqOutp, and tRotorSysEqOutp), FIG. 6 also includes outputs (“stTqDernCoordSysEqMax” and “stTqDernCoordSysEqMin”) representing which of the available input sources is responsible for the temperature and torque outputs (the stator temperature, the rotor temperature, the overall torque minimum, the overall torque maximum outputs). The outputs “pwrSysEqIvtrDchgMax” and “pwrSysEqIvtrRgnMax” represent the available power limits for the MCU 115 considering assumption of a fixed power consumption by low-voltage system electronics and may be utilized to reserve specific power levels to power the remainder electrical components of the vehicle 105.

In subfunction “BMS_INTF_SYSEQUITY” BMS signals received from via a controller area network (CAN) are assigned and a model flowrate derived from coolant pressure sensor is calculated. In the subfunction “BMS_INTF_SYSEQUITY,” system equity model-related signals such as power limits, current limits, and battery voltage may be sorted as assigned to their respective HCU 130 internal signal by calibration or the corresponding calibration value cfg_XXX_SysEquitySel_C.

In subfunction “FLOWCOOLTESSCALC” model flowrate derived from coolant pressure sensors is calculated. The calibration curve “flowCooltEssCnvnSysEq_T” is used to model flow rate from coolant pressure sensor input. The input signal may be selected from among: a first coolant pressure sensor (default), a second coolant pressure sensor, or a default value “pBmsCooltDef_C.” Alternatively, a constant flowrate “CooltEssSysEquityDef_C” may be output with the application of “cfgFlowCooltEssSysEquityDef_C”.

In subfunction “MGU_RATETRANSITION” electric motor speed and torque received from the MCU 115 via CAN at a 1 millisecond (ms) rate may be taken directly for use in the main function of the system equity model, or a moving average of “nrMguRtMovgAvrgSysEquity_C” samples can be applied by setting the value of “cfgMguRtSysEquitySel_C” to true.

The subfunction “SYSEQUITY” represents the main function of the system equity model (software) at a high level.

The subfunction “SysEquity_Mgu_Mcu” represents the main calculation performed by the system equity model. The subfunction “SysEquity_Mgu_Mcu” is responsible for calculating the overall outputs (torque limits, operating temperatures) of the system equity model.

The subfunction “INIT_BLOCK” is responsible for the determining an initial rotor temperature and an initial stator temperature. Upon initialization, if the ECU off time has exceeded threshold “tiTRstThd_C”, the MGU cooldown temperature models based upon last known temperatures stored to memory in a previous ECU cycle will no longer be considered and instead, the value received via CAN from MCU 115 will be used.

In subfunction “COOLDOWN_MODEL_ROTOR COOLDOWN_MODEL_STATOR” a cooldown temperature model of the MGU is determined. Based on the ECU off time and temperature deltas between each last stored value, maps “tRotorReIniSysEq_M” and “tStatorReIniSysEq_M” are applied to calculate initial temperature for the MGU rotor and stator, respectively. In the case of rotor initialization temperature, an additional factor facWghtTStatorSysEq_C is applied to the delta between MGU coolant temperature and modeled stator initialization temperature, and the resulting output is added to the modeled rotor initialization temperature.

In subfunction “MCU_PENALTY” a penalty reduction of torque based on inverter coolant temperature and flowrate is determined. Derating of minimum and maximum torque may be applied when inverter coolant flow is below a minimum defined in curve “facPnltyIvtrCooltFlowSysEq_T” and MCU coolant inlet temperature is above a maximum in “facPnltyIvtrCooltInSysEq_T”. The curves should be calibrated such that inside of the respective limits the derate factor is 1 (no derate).

In subfunction “MGU_PENALTY” a penalty reduction of torque is determined based on MGU coolant flowrate and temperature and a bellhousing temperature. Deration factors based on MGU coolant flowrate as well as MGU inlet and bellhousing temperature are applied in the respective curves. The intent is that a hybrid system with higher flow rates will not be rewarded with better cooling. A maximum “allowed” flowrate of “flowCooltMcuMinSysEq_C” is defined. A maximum “allowed” MGU coolant inlet temperature “tCooltInEmMinSysEq_C” is also applied.

In subfunction “MGU_PERFORMANCE” a MGU temperature simulation and derating strategy is determined. In some implementations, subfunction “DERATING_MODEL” and subfunction “MGU_TEMPERATURE_SIM” are included in subfunction “MGU_PERFORMANCE.”

In subfunction “DERATING_MODEL” a selection of electric motor deration based on maps or fixed limits is done via cfgTEmDerLimSysEqSel_C. In some implementations, subfunction “DeratingBasedOnFixedLimits” and subfunction “DeratingBasedOnMapLimits” (described below) are included in the subfunction “DERATING_MODEL.”

In subfunction “DeratingBasedOnFixedLimits” deration of power and torque based on overall system temperature limits for rotor and stator protection (defined by “pwrSysEqMax_C” and “tqSysEqMax_C”) is determined by the multiplication of power and torque factor calibration curves for rotor and stator temperature. This deration is for the purposes of the system equity model only. Component protection is achieved by executing software included in the MCU 115.

In subfunction “DeratingBasedOnMapLimits” voltage and electric motor speed-based maps calculated in MGU_TORQUECURVE may be used for temperature-based torque deration based on calibration curves “facTqDerTRottorTqMapSysEq_T” and “facTqDerTStatorTqMapSysEq_T”. The factors (values between 0 and 1) output from these calibration curves are based on the rotor and stator temperature and should be calibrated in accordance with the component and system temperature limits. This deration is for the purposes of system equity model only. Component protection is achieved by executing software included in the MCU 115.

In subfunction “MGU_TEMPERATURE_SIM” the electric machine rotor and stator temperature are calculated. In some implementations, subfunction “StatorPowerLossCalculation”, subfunction “RotorPowerLessCalculation”, subfunction “MguThermalExchange”, subfunction “StatorTemperatureCalculation” (described below), and subfunction “RotorTemperatureCalculation”” are included in subfunction “MGU_TEMPERATURE_SIM.”

In subfunction “MguThermalExchange” thermal power loss of the electric motor through heat conduction is modeled. In some implementations, subfunction “RotorThermalExchange,” and subfunction “StatorThermalExchange” (described below) are performed within subfunction “MGU_THERMAL_EXCHANGE.”

In subfunctions “RotorPowerLossCalculation” and “StatorPowerLossCalculation” electrical power losses relating to the electric motor are calculated. The electrical loss maps “pwrLossRotorSysEq_M” and “pwrLossStatorSysEq_M” calculate losses based on the electric motor speed and the effective phase current (filtered). Additional influencing factors are utilized in the calculation if necessary and include a rotor temperature factor, a stator temperature factor, and a switching mode-based factor (including switching frequency if applicable). The product of the rotor and stator power losses and their associated secondary factors are output as the overall electrical power losses for the rotor and the stator.

In subfunction “RotorThermalExchange” thermal power loss due conduction through electric motor rotor is modeled. Thermal conductivity between the MGU rotor and both the coolant and stator are modeled by calibration curves “tendRotorCooltSysEq_T” and “tendRotorStatorSysEq_T”, respectively with a basis of motor speed. The resulting conductivities are multiplied by the respective temperature differences yielding power loss through thermal conduction (negative values). The sum of these losses in addition to rotor electrical losses is output as overall power loss attributed to the rotor.

In subfunction “StatorThermalExchange” thermal power loss due to conduction through electric motor stator is modeled. Thermal conductivity between the MGU stator and both the coolant and the rotor are modeled. Conductivity from the stator to the rotor is modeled by calibration curve “tendStatorRotorSysEq_T” and is based on the speed of the electric motor. The resultant output conductivity is multiplied by the temperature delta between the rotor and stator to yield the power loss through the rotor-stator path. Power loss from the stator to the coolant is the product of conductivity “tendStatorCooltSysEq_C” and the delta temperature between stator and the coolant. The sum of these losses (negative values) in addition to stator electrical losses is output as overall power loss attributed to the stator.

In subfunctions “RotorTemperatureCalculation” and “StatorTemperatureCalculation” a modeled rotor temperature and a modeled stator temperature are determined. A rotor and stator temperature calculation is made in consideration of the individual thermal capacities and conductivity models for each subcomponent of the system 100, as well as the initialization model temperatures. The maximum of the corresponding model temperatures and the measured temperatures received from the MCU 115 are output for use by the system equity model. Additionally, the values are prepared for storage to memory for use upon next ECU initialization.

In subfunction “MGU_TORQUECURVE” the maximum and minimum torque for deployment is calculated.

In subfunction ‘DRV_LOSS_SYSEQ″ mechanical losses are calculated. Friction losses as torque in the electric motor are determined in the table “tqlvtrFricSysEq_T” based on rotational speed. After conversion to power, an overall speed-based efficiency map is applied and finally the mechanical loss (in Watts) is output.

In subfunction “TQ_FROM_BATT_SYSEQ” torque limitations from power limits are calculated. In the conversion of power limits received from the BMS 125 via CAN into toque limits there is the opportunity for inversion to occur in case of differing sign conventions via cfgPwrSysEqIvtrSignInvrt_C.

In subfunction “TQ_FROM_MAP” electric motor torque limits are calculated. Maximum and minimum torques based on voltage and electric motor speed are output according to the maps “tqEmMaxSysEq_M” and “tqEmMinSysEq_M”.

In subfunction “NEM_COORDINATION” coordination of electric motor speed signal in low speed area is achieved. To better handle function calculations at very low speeds, the electric motor speed will be considered as the default value nEmMinDefSysEq_C when an inverter supplied speed is less than cfgNEmMinLimSysEq_C.

In subfunction “TEMPERATURE_OUTPUT” temperatures for output from system equity model are selected. With the calibration cfgSysEqTempSel_C, the rotor and stator temperatures which are output on a public CAN can be selected as follows: 0: measured temperatures (originating in MCU) 1: system equity model temps 2: MAX (system equity model temps, system equity model initialization temperatures) 3: system equity model temps limited to +/−tTolSysEqOutp_C degC above/below measured temperatures.

Thus, examples, aspects, and features herein provide, among other things, systems and methods for ensuring equitable performance of hybrid systems.

What is claimed is:

1. A system for ensuring equitable performance of hybrid systems, the system comprising:
a battery;
an electric motor;
a motor controller; and
an electronic processor, the electronic processor configured to:
determine power limits for the motor controller;
determine physical torque limits based on physical limits of the battery and the electric motor;
based on a coolant flow rate, determine a coolant flow penalty factor;
based on a first coolant temperature and a second coolant temperature, determine a coolant temperature penalty factor;
determine modeled stator temperature and modeled rotor temperature limits;
determine a stator temperature and a rotor temperature;
using the power limits for the motor controller, the physical torque limits, the coolant flow penalty factor, the coolant temperature penalty factor, and the modeled stator temperature and modeled rotor temperature limits, determine an overall torque minimum and an overall torque maximum; and
control the electric motor based on the overall torque minimum and the overall torque maximum.

2. The system according to claim 1, wherein the electronic processor is configured to determine a stator temperature and a rotor temperature by:
receiving a measured stator temperature and a measured rotor temperature;
determining an initial stator temperature and an initial rotor temperature;
determining a modeled stator temperature and a modeled rotor temperature; and
determining the stator temperature and the rotor temperature to be one of the measured stator temperature and the measured rotor temperature, the initial stator temperature and the initial rotor temperature, and the modeled stator temperature and the modeled rotor temperature.

3. The system according to claim 2, wherein the electronic processor is configured to determine a modeled stator temperature and a modeled rotor temperature by:
using a speed of the electric motor, a torque of the electric motor, a voltage of the battery, a switching method of the electric motor, a switching frequency of the electric motor, a phase current of the electric motor, and the initial stator temperature, determining the modeled stator temperature; and
using the speed of the electric motor, the torque of the electric motor, the voltage of the battery, the switching method of the electric motor, the switching frequency of the electric motor, the phase current of the electric motor, and the initial rotor temperature, determining the modeled rotor temperature.

4. The system according to claim 2, wherein the electronic processor is configured to determine an initial stator temperature and an initial rotor temperature by:
using the second coolant temperature, the measured rotor temperature, and an amount of time that an electronic control unit is off, determining the initial rotor temperature; and
using the second coolant temperature, the measured stator temperature, and the amount of time that the electronic control unit is off, determining the initial stator temperature.

5. The system according to claim 1, wherein the electronic processor is configured to determine power limits for the motor controller by:
using a battery power limit, a DCDC converter voltage, a current, and a power value, determining the power limits for the motor controller.

6. The system according to claim 1, wherein the electronic processor is configured to determine physical torque limits based on physical limits of the battery and the electric motor by:
using a speed of the electric motor, a torque of the electric motor, a battery voltage, and the power limits for the motor controller, determining the physical torque limits.

7. The system according to claim 1, wherein the electronic processor is further configured to:
using pressure measurements from a first coolant pressure sensor and a second coolant pressure sensor, determine the coolant flow rate for a motor generator unit, wherein the motor generator unit includes the electric motor.

8. The system according to claim 1, wherein the electronic processor is further configured to:
receive, from a coolant temperature sensor, the first coolant temperature and the second coolant temperature, wherein the first coolant temperature is an input coolant temperature for a motor control unit and the second coolant temperature is an input coolant temperature for a motor generator unit.

9. The system according to claim 1, wherein the modeled stator temperature and modeled rotor temperature limits include a minimum torque determined based on a modeled stator temperature and a modeled rotor temperature and a maximum torque determined based on the modeled stator temperature and the modeled rotor temperature.

10. A method for ensuring equitable performance of hybrid systems, the method comprising:
determining power limits for a motor controller;
determining physical torque limits based on physical limits of a battery and an electric motor;
based on a coolant flow rate, determining a coolant flow penalty factor;
based on a first coolant temperature and a second coolant temperature, determining a coolant temperature penalty factor;
determining modeled stator temperature and modeled rotor temperature limits;
determining a stator temperature and a rotor temperature;
using the power limits for the motor controller, the physical torque limits, the coolant flow penalty factor, the coolant temperature penalty factor, and the modeled stator temperature and modeled rotor temperature limits, determining an overall torque minimum and an overall torque maximum; and
controlling the electric motor based on the overall torque minimum and the overall torque maximum.

11. The method according to claim 10, wherein determining a stator temperature and a rotor temperature includes:
receiving a measured stator temperature and a measured rotor temperature;
determining an initial stator temperature and an initial rotor temperature;
determining a modeled stator temperature and a modeled rotor temperature; and
determining the stator temperature and the rotor temperature to be one of the measured stator temperature and the measured rotor temperature, the initial stator temperature and the initial rotor temperature, and the modeled stator temperature and the modeled rotor temperature.

12. The method according to claim 11, wherein determining a modeled stator temperature and a modeled rotor temperature includes:
using a speed of the electric motor, a torque of the electric motor, a voltage of the battery, a switching method of the electric motor, a switching frequency of the electric motor, a phase current of the electric motor, and the initial stator temperature, determining the modeled stator temperature; and
using the speed of the electric motor, the torque of the electric motor, the voltage of the battery, the switching method of the electric motor, the switching frequency of the electric motor, the phase current of the electric motor, and the initial rotor temperature, determining the modeled rotor temperature.

13. The method according to claim 11, wherein determining an initial stator temperature and an initial rotor temperature includes:
using the second coolant temperature, the measured rotor temperature, and an amount of time that an electronic control unit is off, determining the initial rotor temperature; and
using the second coolant temperature, the measured stator temperature, and the amount of time that the electronic control unit is off, determining the initial stator temperature.

14. The method according to claim 10, wherein determining power limits for the motor controller includes:
using a battery power limit, a DCDC converter voltage, a current, and a power value, determining the power limits for the motor controller.

15. The method according to claim 10, wherein determining physical torque limits based on physical limits of the battery and the electric motor includes:
using a speed of the electric motor, a torque of the electric motor, a battery voltage, and the power limits for the motor controller, determining the physical torque limits.

16. The method according to claim 10, wherein the method further includes:
using pressure measurements from a first coolant pressure sensor and a second coolant pressure sensor, determining the coolant flow rate for a motor generator unit, wherein the motor generator unit includes the electric motor.

17. The method according to claim 10, wherein the method further includes:
receiving, from a coolant temperature sensor, the first coolant temperature and the second coolant temperature, wherein the first coolant temperature is an input coolant temperature for a motor control unit and the second coolant temperature is an input coolant temperature for a motor generator unit.

18. The method according to claim 10, wherein the modeled stator temperature and modeled rotor temperature limits include a minimum torque determined based on a modeled stator temperature and a modeled rotor temperature and a maximum torque determined based on the modeled stator temperature and the modeled rotor temperature.
